(19) United States
(12) Patent Application Publication
(10) Pub. No.: US 2010/0089477 A1
(43) Pub. Date: Apr. 15, 2010

(54) Plug for Sealed Closing of a Pipe

(75) Inventor: Hans-Guenter Grobelny, Herne (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: BALCKE-DURR GMBH, Ratingen (DE)

(21) Appl. No.: 12/577,890

(22) Filed: Oct. 13, 2009

(30) Foreign Application Priority Data
Oct. 14, 2008 (EP) 08017975.7

(51) Int. Cl. F16L 55/10

(52) U.S. Cl. 138/93; 138/89

(57) ABSTRACT

A plug for the sealed closing of a pipe is provided. The plug comprises a sleeve and a cylindrical main body having a connection for a pressure line. The sleeve is coupled to the cylindrical main body so that the sleeve and the cylindrical main body form an outwardly sealed pressurized area, which communicates with the connection.

### CROSS-REFERENCE TO RELATED APPLICATIONS

This application claims priority to foreign Patent Application EP 08017975.7, filed on Oct. 14, 2008, the disclosure of which is incorporated herein by reference in its entirety.

### FIELD OF THE INVENTION

The present invention relates to a plug for the sealed closing of a pipe, which comprises a cylindrical main body.

### BACKGROUND OF THE INVENTION

Closing a pipe using a plug, which has an elastic material and whose external radius is slightly greater than the internal radius of the pipe is known, so that the plug can be fastened in the pipe using a press fit. This results in a sealed closure of the pipe, but is only suitable for low pressures in the pipe. Furthermore, screwing the plug together with the pipe via internal or external threads is known. Fundamentally, at least a seal element such as an O-ring is also provided for the sealed closure. Furthermore, a suitable plug can be welded to the pipe to form a seal.

In a heat exchanger for industrial purposes, for example, for cooling or preheating in a power plant, pipes of up to 13.5 m in length are used. These pipes must be partially closed after their installation. Depending on the application, the pipes must be closed at their axial ends or also spaced apart from their axial ends. Furthermore, very high pressures may prevail in pipes of this type, so that it can be necessary to preferably leave walls of the pipes as intact as possible.

A plug for closing a pipe and/or a pipeline is known from U.S. Pat. No. 2,130,030 A. This plug comprises a main body and a deformable sleeve situated around the main body, which can have an internal pressure applied on the main body side and thus presses elastically against the pipe wall, whereby a closure of the affected pipe is achieved. It is disadvantageous in this case, inter alia, that a continuous internal pressure must be applied to the elastic sleeve for the sealed closure of the pipe.

### SUMMARY OF THE INVENTION

Embodiments of the present invention advantageously provide a plug and a method for the sealed closing of a pipe, which allows a sealed closure of the affected pipe in a simple way, in particular so that the closure is sealed even in the event of high pressures in the pipe.

The plug comprises a deformable sleeve and a cylindrical main body having a connection for a pressure line. The sleeve is coupled to the cylindrical main body so that the sleeve and the cylindrical main body form an outwardly sealed pressurized area, which communicates with the connection.

For the sealed closure of the pipe, the plug is inserted into the pipe and pressure is applied to the connection of the cylindrical main body and thus the pressurized area of the plug in such a way that the sleeve expands in the pressurized area and thus seals the pipe closed. The pressure is selected as sufficiently high that the sleeve deforms beyond the yield point of the material used, so that the sleeve remains permanently deformed even without pressure after its deformation. The pressure required for this purpose can be empirically ascertained as a function of the material used, for example, on a suitable test stand.

The plug can advantageously be easily inserted an arbitrary distance into the pipe via an appropriately long pressure line and fixed to form a seal by the pressure application at an arbitrary point of the pipe. The plug additionally dispenses with processing of the pipe, because the plug seals the pipe as a result of the occurring press fit. Furthermore, the pressure which is applied to the pressurized area can be selected as sufficiently high so that the plug seals the pipe closed even in the event of extreme pressures in the pipe. For example, the pressure which is applied to the pressurized area can be selected as sufficiently high that the expanding sleeve deforms the pipe, whereby a form fit is produced between sleeve and pipe in addition to the press fit.

In an advantageous design, the pressurized area communicates with the connection via a pressure supply in the cylindrical main body. The pressure supply preferably comprises two holes, one of which extends in the axial direction and one of which extends in the radial direction of the cylindrical main body. The hole in the radial direction opens at one of its axial ends into the pressurized area and/or into the free work volume and at its other axial end into the axial hole. The axial hole, in contrast, preferably opens at its end facing away from the radial hole into the connection. This allows the communication between the pressurized area and/or the free work volume and the connection particularly easily.

In a further advantageous design, a valve is situated in the pressure supply. The valve is preferably a check valve, through which a pressure dissipation in the pressurized area can be avoided, when the pressure via the pressure line is decreased and/or the pressure line is removed from the connection. Alternatively or additionally, an overpressure valve can be situated in the pressure supply, which allows the dissipation of overpressure in the pressurized area.

In a further advantageous design, the external radius of the cylindrical main body in the pressurized area is at least partially smaller than the internal radius of the sleeve. In this way, a free work volume is formed in the pressurized area. This can contribute to the sleeve preferably bulging outward in the area of the free work volume.

In a further advantageous design, the sleeve is coupled at its axial ends to the cylindrical main body. This can contribute to coupling the sleeve to the cylindrical main body particularly easily.

In a further advantageous design, the sleeve is welded to the cylindrical main body. This allows the sealed coupling of the cylindrical main body to the sleeve easily.

In a further advantageous design, the cylindrical main body has a first axial section, which is en-closed by the sleeve in the radial direction. Furthermore, the cylindrical main body has a second axial section, which comprises the connection and which lies outside the sleeve in the axial direction. This allows one or more devices to be attached in the first axial section, which may communicate with the surroundings of the plug. For example, the valve, in particular an over-pressure valve can be situated in the first axial section, which allows a pressure dissipation out-side the sleeve in the event of excess pressure.

In an advantageous design, a wall thickness of the sleeve is significantly less than the internal radius of the sleeve. This contributes to the sleeve bulging outward sufficiently at a predetermined pressure, without the sleeve and/or the cylindrical main body being damaged because of the pressure.

### BRIEF DESCRIPTION OF THE DRAWINGS

The invention is explained in greater detail hereafter on the basis of two exemplary embodiments illustrated in the drawings. In the schematic figures:

FIG. 1 shows a plug in the unloaded state,

FIG. 2 shows the plug according to FIG. 1 in the loaded state situated in a pipe.

### DETAILED DESCRIPTION

The invention will now be described with reference to the drawing figures, in which like reference numerals refer to like parts throughout.

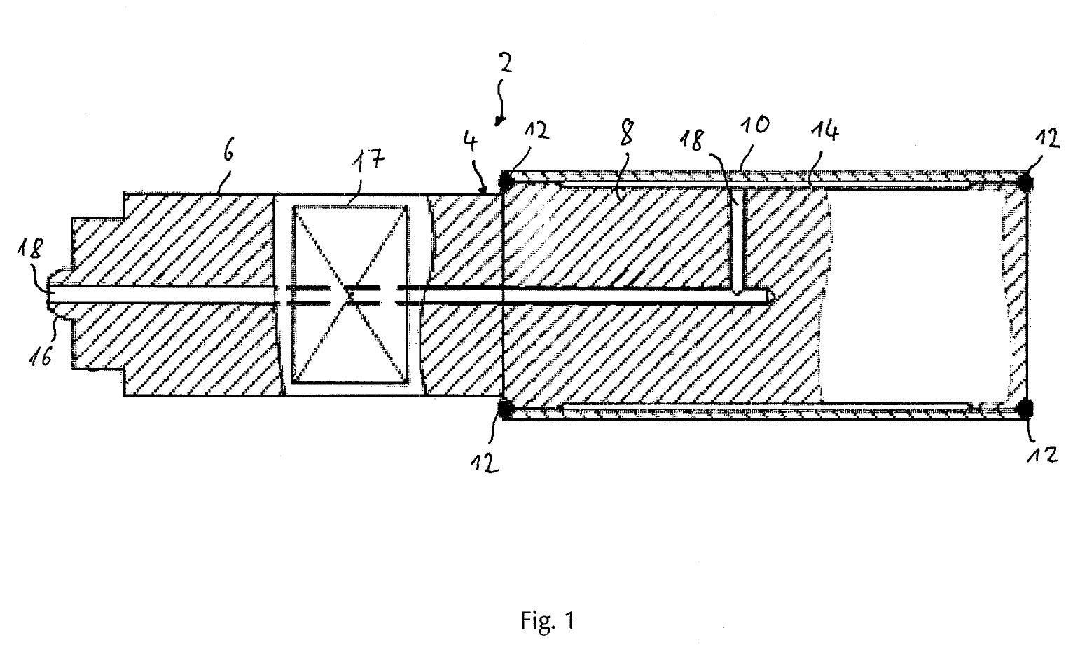

FIG. 1 shows a plug 2, which comprises an essentially cylindrical main body 4. The cylindrical main body 4 can comprise a first and a second axial section 6, 8. Alternatively thereto, the cylindrical main body 4 can also comprise only one axial section or more axial sections. The cylindrical main body 4 is enclosed in the radial direction by a sleeve 10 in the area of the second axial section 8. The sleeve 10 preferably presses against the second axial section 8 at least in its axial end areas. In these axial end areas, the sleeve 10 is coupled sealed to the cylindrical main body 4, for example, via two circular weld seams 12 running around the cylindrical main body 4. In addition, seal elements may be provided between the sleeve 10 and the second axial section 8. Furthermore, the sleeve 10 and the cylindrical main body 4 may also be coupled sealed to one an-other via connection means other than the weld seams 12.

A pressurized area 14 is formed in the radial direction between the second section 8 and the sleeve 10. The pressurized area 14 communicates via a pressure supply 18 with a connection 16, which is preferably implemented on one axial end area of the first axial section 6, which faces away from the sleeve 10. The pressure supply 18 comprises one, preferably at least two holes, for example, in particular a longitudinal hole in the axial direction, which opens on one side into the connection 16 and opens on the other side into a radial hole, the radial hole opening at its other axial end into the pressurized area 14.

At least one valve 17 is preferably situated in the pressure supply 18. The valve 17 can be implemented as a check valve, for example, which prevents a pressure dissipation in the pressurized area when the pressure via the pressure line is decreased and/or the pressure line is removed from the connection 16. Alternatively or additionally, an overpressure valve can be provided, which opens in the event of an excess pressure in the pressure supply 18 and thus prevents damage of the plug 2.

An external radius of the second axial section 8 is preferably at least partially less than an internal radius of the sleeve 10, so that a free work volume is formed in the pressurized area 14. The sleeve 10 is prevented from adhering excessively strongly to the second axial section 8 by the free work volume, for example, because of adhesion forces. This contributes in a simple way to the sleeve bulging outward as intended upon a pressure application to the pressurized area 14.

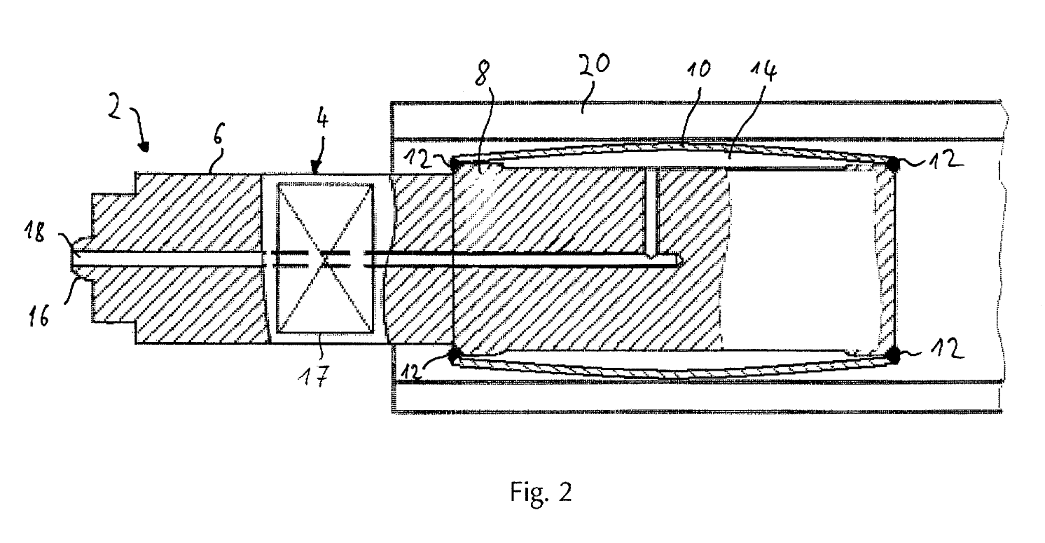

FIG. 2 shows the plug 2 situated in a pipe 20. The plug 2, in particular the sleeve 10, is preferably implemented as matching with the pipe 20 in regard to its external radius so that the plug 2 is easily insertable into the pipe 20, but there is not so much play between the sleeve 10 and the internal radius of the pipe 20 that a sealed closure of the pipe 20 would no longer be possible. For example, the external radius of the sleeve 10 can be selected so that the plug 2 is just still easily movable back and forth in the pipe 20.

Upon use of the plug 2, the plug 2 is connected to a high-pressure line at the connection 16. The high-pressure line can be used for inserting the plug 2 an arbitrary distance into the pipe 20, in addition to the pressure application. As soon as the plug 2 is at its intended location in the pipe 20, pressure is applied to the free work volume via the pressure line and the pressure supply 18. The pressure can be up to 4000 bar, for example. However, the pressure is preferably selected as a function of the size and the material of the sleeve 10 so that it is deformable be-cause of the pressure, but is not damaged. Furthermore, the material of the sleeve 10 and the pressure are selected so that the plug 2 seals the pipe 20 closed sufficiently at the pressure prevailing later in the pipe 20.

If pressure is now applied to the pressurized area 14, the sleeve 10 bulges outward and is thus fixed sealed in the pipe 20 using a press fit. In addition, the pressure can be selected as sufficiently high that the pipe 20 is deformed in the area of the sleeve 10 by the expansion of the sleeve 10, so that a form fit is generated between the plug 2 and the pipe 20 in addition to the press fit. With sufficiently strong form fit and/or with sufficiently strong deformation of the sleeve 10, the check valve can be dispensed with, because then the deformation of the sleeve 10 is sufficiently great even without pressure in the pressurized area in order to ensure the sealed closure. The pressure is preferably selected as sufficiently high that the sleeve 10 deforms permanently. In particular, the material of the sleeve 10 is strained beyond its yield point of the material, so that the sleeve remains deformed even upon pressure relief after its deformation and thus permanently closes the pipe 20. The pressure used for deforming the sleeve 10 is preferably ascertained empirically as a function of the material used, for example, on a suitable test stand.

The invention is not restricted to the disclosed exemplary embodiments. For example, the cylindrical main body 4 can have more or fewer axial sections 6, 8. Furthermore, two or more sleeves 10 may be provided per plug 2.

Metal, in particular stainless steel, which is resistant to high temperatures and corrosion, comes into consideration as the preferred material for the cylindrical main body 4 and the sleeve 10 of the plug 2. In an advantageous embodiment of the invention, the plug 2 comprises material of the same type as the pipe 20, for example, chromium nickel steel, in order to avoid endangering the permanent seal as much as possible as a result of different thermal expansions of plug 2 and pipe 20. The plug 2 according to the invention is designed for high operating temperatures of up to 300° C. and operating pressures of up to 100 bar in the pipe 20. Typical closures are unsuitable for operating temperatures and pressures this high.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A plug for the sealed closing of a pipe, which comprises a deformable sleeve and a cylindrical main body having a connection for a pressure line, and in which the sleeve is coupled to the cylindrical main body so that the sleeve and the cylindrical main body form an outwardly sealed pressurized area, which communicates with the connection, wherein the sleeve is formed from a permanently deformable material, so that the sleeve remains deformed after its deformation above the yield point of the material and thus permanently closes the pipe.

2. The plug according to claim 1, wherein the pressurized area communicates with the connection via a pressure supply in the cylindrical main body.

3. The plug according to claim 2, wherein a valve is situated in the pressure supply.

4. The plug according to claim 1, wherein the external radius of the cylindrical main body in the pressurized area is at least partially less than the internal radius of the sleeve, and in which a free work volume is thus formed in the pressurized area.

5. The plug according to claim 1, wherein the sleeve is coupled at its axial ends to the cylindrical main body.

6. The plug according to claim 1, wherein the sleeve is welded to the cylindrical main body.

7. The plug according to claim 1, wherein the cylindrical main body has a first axial section, which comprises the connection and which lies outside the sleeve in the axial direction, and the cylindrical main body has a second axial section, which is enclosed in the radial direction by the sleeve.

8. The plug according to claim 1, wherein a wall thickness of the sleeve is significantly less than the internal radius of the sleeve.

9. A method for closing a pipe using the plug according to claim 1, in which the plug is inserted into the pipe and pressure is applied to the connection of the cylindrical main body and thus the pressurized area and/or the free work volume of the plug in such a way that the sleeve expands in the pressurized area so that the material of the sleeve is strained beyond its yield point and thus permanently seals the pipe closed.
